(19) United States
(12) Patent Application Publication
(10) Pub. No.: US 2003/0159248 A1
(43) Pub. Date: Aug. 28, 2003

(54) Three-piece barrel hinge

(76) Inventor: Thomas Dean Gulley, Monrovia, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/080,818

(22) Filed: Feb. 22, 2002

(51) Int. Cl. E05D 11/00

(52) U.S. Cl. 16/273

(57) ABSTRACT

A barrel hinge having a female barrel portion and two male barrel portions. The female barrel portion has a sidewall with an aperture formed therein, a length, two ends, and an outside surface, and an axial bore, with an interior wall surface and a diameter, which extends from end to end. The male barrel portions each have a main body portion with an outer surface, and a pin extension. The pin extensions have a pin length and pin diameter, the pin extensions having ends, the pin diameter being sized to be received within the interior bore of the female barrel portion. The sum of the pin lengths of the pin extensions of the first and second barrel portions is less than the length of the interior bore of the female barrel portion. When the pin extensions of the two male barrel portions are fully inserted into the interior bore of the female barrel portion, a grease reservoir cavity is defined by the space between the ends of the first and second pin extensions and the interior bore and is in the vicinity of the aperture in the sidewall of the female barrel portion. A lubricant fitting is affixed within the aperture in the sidewall of the female barrel portion.

### BACKGROUND OF THE INVENTION

The invention relates to hinges, and more particularly to barrel hinges.

Barrel hinges are widely used in applications that require hingeably attaching heavy structures together, such as ingress and egress ramps for horse trailers, ramps for earth-moving equipment trailers, and the like.

In order to provide for lubrication of barrel hinges, grease fittings can be included in the hinge designs by being attached to ends of a shaft, with a grease channel provided through the shaft so that grease can be released between the pin and the sleeve. However, for long barrel hinges, it can be costly and difficult to bore a grease channel through the pin for delivery of grease between the pin and the sleeve of the barrel hinge.

Prior art barrel hinges having three sleeve sections have been made by providing three separate sleeves made of seamless tubing and an elongate rod which is retained within bores of the sleeves. Once assembled, the two end sleeves are welded at their ends to the ends of the rod, leaving the intermediate sleeve to freely rotate. These welds require additional labor and are more prone to corrosion than the unwelded portions. These prior designs do not lend themselves to lubrication by use of the grease fitting and therefore requires manual frequent lubrication, or more typically, remain unlubricated. Furthermore, seamless tubing is more costly than seamed tubing.

Accordingly, there remains a need for an improved barrel hinge that is easier to manufacture and maintain, is less prone to rust, has better lubrication properties, and has more consistent quality.

### SUMMARY OF THE INVENTION

The invention provides a three-piece barrel hinge design which utilizes less seamless tubing, has better self-lubricating qualities, and has replaceable grease fittings that are not limited in their height. The invention further provides a design which is less prone to rusting and paint chipping and which is easier to set up and maintain.

These and other objects of the invention are met by providing a barrel hinge, comprising:

a female barrel portion having a sidewall with an aperture formed therein, a length, two ends, and an outside surface, and an interior bore, with an interior wall surface and a diameter, which extends from end to end;

a first and second male barrel portion, each male barrel portion having a main body portion with an outer surface, and pin extension, the pin extension having a pin length and pin diameter, the pin extensions having ends, the pin diameter being sized to be received within the interior bore of the female barrel portion, wherein the sum of the pin lengths of the pin extensions of the first and second male barrel portions is less than the length of the interior bore of the female barrel portion, such that when the pin extensions of the first and second male barrel portion are fully inserted into the interior bore of the female barrel portion, a cavity is defined by the space between the ends of the first and second pin extensions and the interior bore, which cavity is in the vicinity of the aperture in the sidewall of the female barrel portion; and

a lubricant fitting affixed within the aperture in the sidewall of the female barrel portion.

### BRIEF DESCRIPTION OF THE DRAWINGS

FIG. 1 is an exploded view of a prior art four-piece barrel hinge design.

FIG. 2 is a view showing the assembled prior art barrel hinge of FIG. 1, attached to a trailer and a ramp for a trailer.

FIG. 3 is an exploded perspective view of the three-piece barrel hinge of the invention.

FIG. 4 is a perspective view of the assembled three-piece barrel hinge of the invention.

FIG. 5 is a partially exposed side view of the three-piece barrel hinge of the invention.

FIG. 6 is a plan view showing the female portions of the three-piece barrel hinge.

FIG. 7 is an end view along view lines 7-7 of FIG. 6.

FIG. 8 is a top plan view of the female barrel of the invention with a grease fitting in place.

FIG. 9 is a side view of the female barrel of FIG. 8.

### DETAILED DESCRIPTION OF THE INVENTION

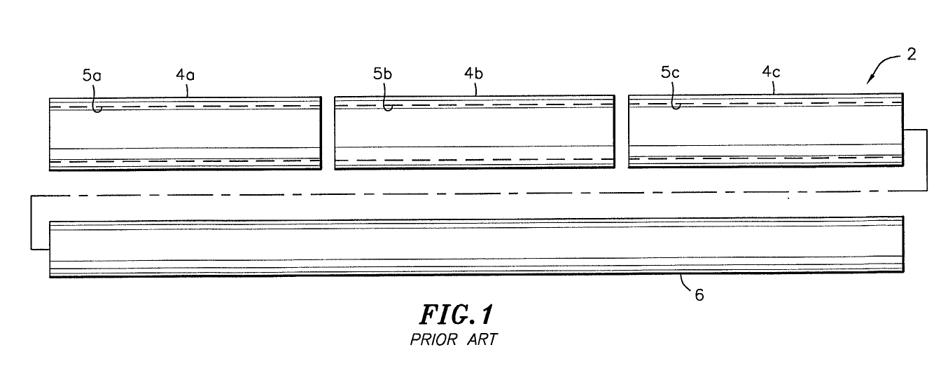

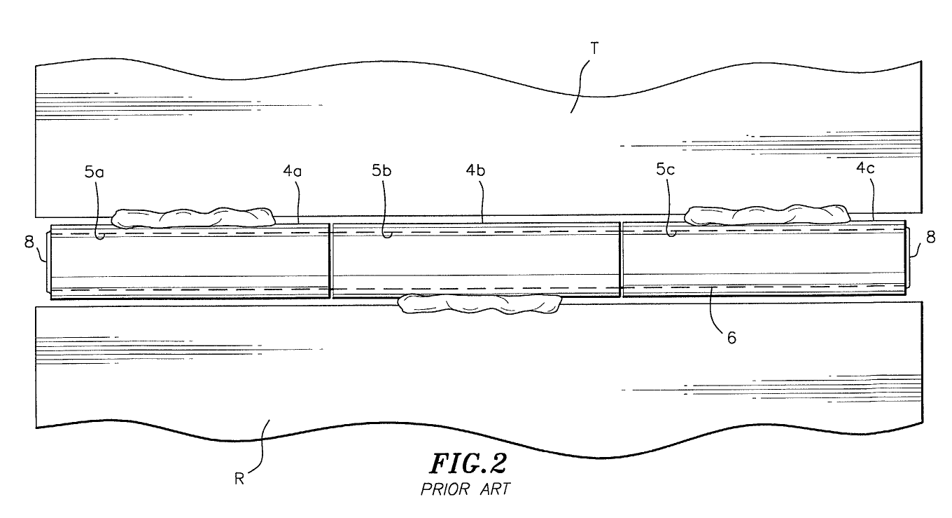

Referring to FIG. 1, there is shown an exploded view of a prior art four-piece barrel hinge design, having three tube sections 4a, 4b and 4c, and a central pin 6 which is sized to be received within axial openings 5a, 5b, and 5c of the sleeves 4a, 4b and 4c. FIG. 2 shows pin 6 placed through axial openings 5a, 5b and 5c of sleeves 4a, 4b and 4c, with sleeves 4a and 4c being welded at their ends 8 to pin 6 to secure same together, and with barrel hinge 2 being welded to a trailer (T) and a ramp thereof (R). Pin 6 can be welded to sleeves 4a and 4c prior to attachment of the barrel hinge to the trailer and ramp, or another application. The welds 8 not only required additional assembly time, but also are more prone to rust and corrosion than unwelded areas. Furthermore, the prior art four-piece barrel hinge require that the sleeves 4a, 4b, and 4c be made from seamless tubing, which is more costly than seamed tubing, or utilize seamed tubing that has been machined on an inside surface thereof to remove the weld line (which can weaken the tubing). In order to provide for lubrication, a grease fitting can optionally be provided in an end of pin 6 with the grease hole formed therethrough which egresses at one or more points in the vicinity of the interface between sleeve 4b and the surface of pin 6 (not shown). However, this requires formation of a long channel through the center of rod which can weaken the rod and requires additional manufacturing steps. If typical grease fittings are threaded into a sidewall of the sleeve, they jut beyond the inner surface of the axial opening in the sleeve and impinge on the pin. It is therefore problematic to use grease fittings in the prior art designs. Furthermore, there is no grease reservoir provided in the prior art design since the most grease that can be retained is limited by the volume available between pin 6 and inner walls of sleeve 4b, which for close fitting pins and sleeves, is very small.

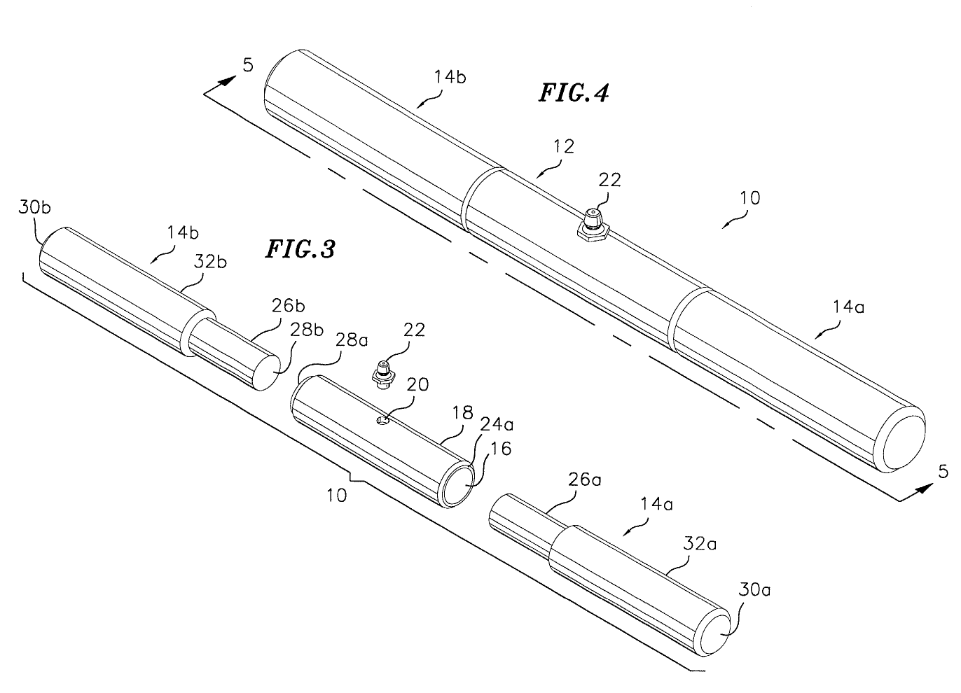

Turning to FIG. 3, there is shown an exploded view of a three-piece barrel hinge of the invention 10, which includes a female barrel 12, and two male barrels 14a and 14b. Female barrel has a cylindrical and axially located bore 16 formed therethrough from end to end (24a through 24b). Female barrel has an outer surface 18 and preferably has a threaded orifice 20 formed therein for receiving a grease fitting 22 therein. Female barrel 12's bore 16 has a predetermined interior diameter.

Male barrels 14a and 14b have cylindrical pin extension 26a and 26b having front faces 28a and 28b, the diameter of which is slightly smaller than that of the interior diameter of opening 16. Male barrels 14a and 14b have opposite ends 30a and 30b, and have exterior surfaces 32a and 32b which were available for welding. Male barrels are preferably identical. Outer surface 18 of female barrel is likewise available for welding to another structure.

Referring to FIG. 4, there is a perspective view showing the three-piece barrel of the invention with pin extensions 26a and 26b of pin extensions male barrels 14a and 14b inserted into opening 16 of female barrel 12 and with grease fitting 22 engaged with threaded opening 20 of female barrel 12.

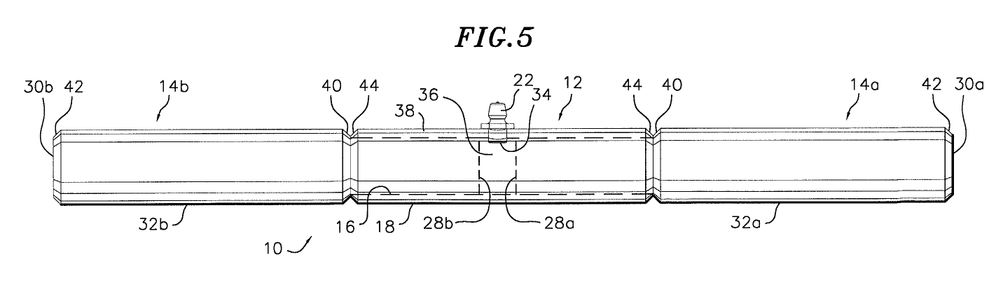

Turning to FIG. 5, there is shown a partial cross-sectional view through view lines 5-5 of FIG. 4, showing the assembled three-piece barrel hinge, with the female barrel 12 exposed. As can be seen, ends 28a and 28b are spaced apart from each other and define a cavity 36 therebetween within female barrel 12. End faces 28a and 28b of pin extension 26a and 26b of male barrels 14a and 14b are sized so that their ends are spaced apart by a distance which is sufficient to clear any possible projection 34a of a grease fitting 22 into cavity 36, and also to provide a sufficient grease volume within cavity 36 so that less maintenance is required for the hinge. An end 34 of grease fitting extends through a wall 38 of female barrel 12 so that grease can be injected into cavity 36 which will serve as a grease reservoir. As grease (or any other known lubricant) is injected into cavity 36 under pressure, it will tend to flow outwardly therefrom to coat and lubricate inner surfaces of opening 16 of female sleeve 12 and outside surfaces of insert portions 26a and 26b of male barrels 14a and 14b, thereby providing for good lubrication for the moving contact surfaces.

If grease fitting 22 and/or bore 20 become damaged, grease fitting 22 can be replaced and/or hole 22 can be rethreaded without requiring removal of the barrel hinge from the trailer to which it is welded.

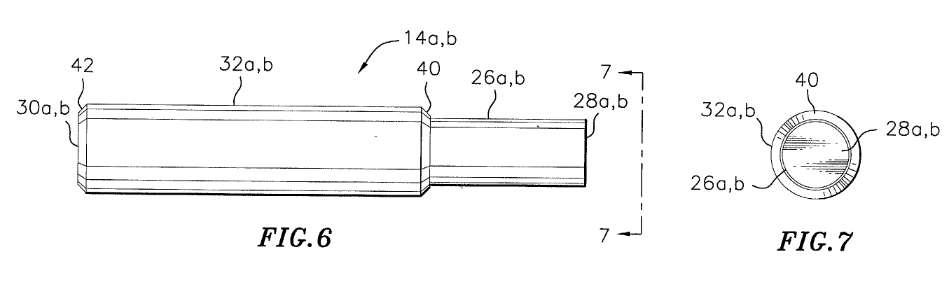

Turning to FIGS. 6 and 7, there is shown a top view of male barrel 14a and 14b. At an interface of outer surface 32a and 32b and pin extension 26a and 26b, edges thereof 40 are preferably slightly beveled to provide a paint retention surface such that when the three piece barrel is fully assembled as shown in FIGS. 4 and 5, contact between female barrel 12 and male barrels 14a and 14b will not cause paint to excessively chip off along edges 40, thereby improving the appearance of the painted hinge installed. Ends 30a and 30b can also preferably be beveled 42.

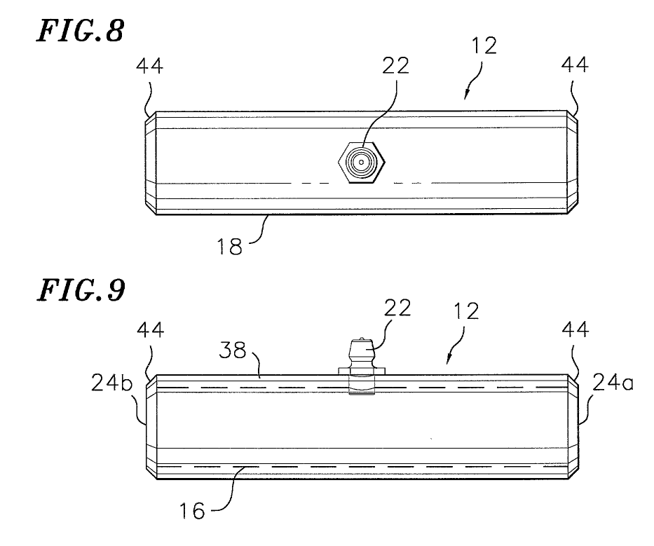

Turning lastly to FIGS. 8 and 9, there is shown a top plan view and an exposed side view of female barrel 12. Outer edges 44 of female barrel are also preferably beveled slightly so that when female barrel is assembled with male barrels, there was less likelihood of paint chipping along edges 40 and 42, which will provide for an improved paint longevity of the device.

In the design of the invention, since there will be better lubrication at the points of motion, the tolerances between pin extensions 26a and 26b and interior diameter 16 of female barrel can be made closer, thereby providing a more precise and smooth operating hinge.

While in practice there may be grease fittings available that do not have any portions which extend downwardly beyond inside wall 16 of female barrel, the provision of a cavity 36 is highly beneficial as a grease reservoir.

The three-piece barrel hinge design of the invention provides further advantages. For example, unlike prior art designs, only the female barrel need be assembled from seamless tubing which is less expensive than seamed tubing.

Male barrels 14a and 14b can be simply machined from round stock and the diameter of pin extensions 26a and 26b can be machined to be within whatever tolerances are desired of the interior diameter of female barrels 12. Furthermore, there is no welding required of a central pin which would otherwise be required to go through all three barrels of the prior art barrel hinge. This means that there is no welding required prior to attachment of the three piece barrel hinge to a trailer or other structure.

In addition to forming the male barrel portions from bar stocks, the male barrel portions can alternately be formed with thick walled tubing, with the pin extensions being machine downed to fit within the axial bore, and with plugs or caps preferably inserted into the bases of the pin extensions.

Having thus described the exemplary embodiments of the present invention, it should be understood by those skilled in the art that the above disclosures are exemplary only and that various other alternatives, adaptations, and modifications may be made within the scope of the present invention. The presently disclosed embodiment is to be considered in all respects as illustrative and not restrictive. The scope of the invention being indicated by the appended claims rather than the foregoing description, and all changes which come within the meaning and range of equivalency of the claims are, therefore, intended to be embraced therein.

What is claimed is:

1. A barrel hinge, comprising:
a female barrel portion having a sidewall with an aperture formed therein, a length, two ends, and an outside surface, and an axial bore, having an interior wall surface and a diameter, the axial bore extending from end to end;
a first and second male barrel portion, each male barrel portion having a main body portion with an outer surface, and a pin extension, the pin extension having a pin length and pin diameter, the pin extensions having ends, the pin diameter being sized to be rotatably received within the axial bore of the female barrel portion, wherein the sum of the pin lengths of the pin extensions of the first and second male barrel portions is less than the length of the axial bore of the female barrel portion, such that when the pin extensions of the first and second male barrel portion are fully inserted into the interior bore of the female barrel portion, a cavity is defined by the space between the ends of the first and second pin extensions and the interior bore, which cavity is in the vicinity of the aperture in the sidewall of the female barrel portion; and
a lubricant fitting affixed within the aperture in the sidewall of the female barrel portion.

2. The barrel hinge of claim 1, wherein the two ends of the female barrel portion are beveled where the outer surface meets the two ends, and wherein the main body portions of the male barrel portions are beveled where the pin extensions extend therefrom.

3. The barrel hinge of claim 1, wherein the aperture in the sidewall of the female barrel portion is threaded and the lubricant fitting is threadably engaged therewith.

4. The barrel hinge of claim 1, wherein the main body portion of the male barrel portions and the female barrel portion are cylindrical.

5. The barrel hinge of claim 1, wherein the female barrel portion comprises a section of seamless cylindrical tubing.

6. The barrel hinge of claim 1, wherein each of the male barrel portions is formed from a section of bar stock with the pin extension portions being formed by machining at one end thereof.

7. The barrel hinge of claim 1, wherein each of the male barrel portions is formed from a section of tubing stock with the pin extension portions machined at one end thereof.

8. The barrel hinge of claim 1, wherein the first and second male barrel portions are identical.

9. A three-piece barrel hinge, comprising:
a female barrel portion having a length, two ends, and an outside surface, an axial bore with a diameter extending from end to end therethrough, and an aperture formed on a sidewall;
a lubricant fitting placed in the aperture; and
a first and second male barrel portion, each male barrel portion having a pin extension having a pin length, a pin diameter, and a pin end, the pin diameter being sized to be rotatably received within the axial bore of the female barrel portion, wherein when the pin extensions of the first and second barrel portions are inserted into the interior bore of the female barrel portion, the pin ends are spaced apart to define a cavity therebetween, which cavity is in the vicinity of the lubricant fitting.

10. The barrel hinge of claim 9, wherein the two ends of the female barrel portion are beveled where the outer surface meets the two ends, and wherein the main body portions of the male barrel portions are beveled where the pin extensions extend therefrom.

11. The barrel hinge of claim 9, wherein the aperture in the sidewall of the female barrel portion is threaded and the lubricant fitting is threadably engaged therewith.

12. The barrel hinge of claim 9, wherein the lubricant fitting is press fitted into the aperture in the sidewall of the female barrel portion.

13. The barrel hinge of claim 9, wherein the main body portion of the male barrel portions and the female barrel portion are cylindrical.

14. The barrel hinge of claim 9, wherein the female barrel portion comprises a section of seamless cylindrical tubing.

15. The barrel hinge of claim 9, wherein each of the male barrel portions is formed from a section of bar stock with the pin extension portions being formed at one end thereof.

16. The barrel hinge of claim 9, wherein each of the male barrel portions is formed from a section of tubing stock with the pin extension portions machined at one end thereof.

17. A three-piece barrel hinge, comprising:
a female barrel portion made from a section of seamless tubing having a length, two ends, and an outside surface, an interior bore with a diameter extending from end to end therethrough;
a first and second male barrel portion, each male barrel portion formed from a single section of material and having a pin extension having a pin length, a pin diameter, and a pin end, the pin diameter being sized to be received within the interior bore of the female barrel portion, wherein when the pin extensions of the first and second barrel portions are inserted into the interior bore of the female barrel portion, the pin ends are spaced apart.
